(19) United States
(12) Patent Application Publication
(10) Pub. No.: US 2026/0213630 A1
(43) Pub. Date: Jul. 23, 2026

(54) SYSTEM AND METHOD OF APPLYING ULTRA-CONDUCTIVE COMPOSITE MATERIAL ON A SUBSTRATE USED IN ELECTRICAL MOTORS

(71) Applicant: GM Global Technology Operations LLC, Detroit, MI (US)

(72) Inventors: Yi Liu, Troy, MI (US); Qigui Wang, Rochester Hills, MI (US); Liang Wang, Rochester Hills, MI (US); Kestutis A. Sonta, Troy, MI (US)

(73) Assignee: GM Global Technology Operations LLC, Detroit, MI (US)

(21) Appl. No.: 19/035,206

(22) Filed: Jan. 23, 2025

(51) Int. Cl. H02K 15/043; B23K 26/38

(52) U.S. Cl. CPC H02K 15/043; B23K 26/38

(57) ABSTRACT

A system for manufacturing an ultra-conductive winding for an electric motor of a vehicle comprising a substrate extending along a longitudinal axis, an ultra-conductive composite (UCC) foil material having a thickness of 5-30 micrometers and overlapping a portion of the substrate, a substrate support selectively engageable with a portion of the substrate or the UCC material, and a finishing mechanism including a joining mechanism and a cutting mechanism configured to move along or parallel to the longitudinal axis.

### GOVERNMENT FUNDING

This invention was made with Government support under Agreement No. EE0010600 awarded by the United States Department of Energy. The Government may have certain rights in the invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to vehicles and, more particularly, to motors for electric vehicles.

Electric motors are integral components in the propulsion systems of electric vehicles (EVs). These motors typically consist of two main parts: the rotor and the stator. The rotor is the rotating element, while the stator remains stationary. Together, they convert electrical energy into mechanical energy, which powers the vehicle. A crucial element in this energy conversion process is the windings, which are coils of wire that create a magnetic field when an electric current flows through the windings. Further development of the windings is addressed by one or more aspects of the present disclosure.

### SUMMARY

In one configuration, a system for manufacturing an ultra-conductive winding for an electric motor of a vehicle is provided and includes a substrate extending along a longitudinal axis, an ultra-conductive composite (UCC) foil material having a thickness of 5-30 micrometers and overlapping a portion of the substrate, a substrate support selectively engageable with a portion of the substrate or the UCC material, and a finishing mechanism including a joining mechanism and a cutting mechanism configured to move along or parallel to the longitudinal axis.

The system may include one or more of the following optional aspects. For example, the system may further include a first articulation device and a second articulation device spaced from the first articulation device. The first articulation device and the second articulation device can be stepper motors configured to rotate the substrate with respect to the longitudinal axis. The substrate can extend between the first articulation device and the second articulation device and between a tensioner and a holder.

According to at least one aspect, the substrate can be made of copper and can include a rectangular cross section.

According to another aspect, the substrate can be made of copper and can include a round cross section.

According to at least one example, the finishing mechanism can be positioned on a rail that is arranged parallel to the longitudinal axis. The finishing mechanism can be movable along the rail between a first articulation device and a second articulation device.

According to another example, the joining mechanism can be an ultrasonic horn.

According to at least one aspect, the cutting mechanism can be a laser.

In another configuration, a system for manufacturing an ultra-conductive winding for an electric motor is provide and includes a first articulation device and a second articulation device spaced from the first articulation device, a substrate extending along a longitudinal axis and held by the first articulation device and the second articulation device, an ultra-conductive composite (UCC) material held by a tensioner and selectively by a holder, the UCC material overlapping a portion of the substrate, a substrate support selectively engageable with a portion of the substrate or the UCC material, and a finishing mechanism including a joining mechanism and a cutting mechanism that are selectively movable with respect to where the UCC material overlaps the substrate, the finishing mechanism is configured to move between the first articulation device and the second articulation device.

The system may include one or more of the following optional aspects. For example, the first articulation device and the second articulation device may be configured to rotate the substrate about the longitudinal axis.

According to at least one aspect, the joining mechanism can be configured to couple the UCC material to a portion of a perimeter of the substrate. The joining mechanism can be an ultrasonic horn.

According to at least one example, the cutting mechanism is a laser.

In another configuration, an ultra-conductive winding for an electric motor obtained by a process is provided and includes positioning an ultra-conductive composite (UCC) material with respect to a substrate, coupling the UCC material to a first portion of the substrate with a joining mechanism to form a first side of the ultra-conductive winding, cutting the UCC material with a cutting mechanism, rotating the substrate about a longitudinal axis, and coupling another portion of the UCC material to another portion of the substrate with the joining mechanism to form a second side of the ultra-conductive winding.

The ultra-conductive winding may include one or more of the following optional aspects or steps. For example, the process may further include rotating the substrate about the longitudinal axis and coupling another portion of the UCC material to another portion of the substrate with the joining mechanism to form a second side of the ultra-conductive winding. The process may further include rotating the substrate about the longitudinal axis and coupling another portion of the UCC material to another portion of the substrate with the joining mechanism to form a third side of the ultra-conductive winding. The process may further include rotating the substrate about the longitudinal axis and coupling another portion of the UCC material to another portion of the substrate with the joining mechanism to form a fourth side of the ultra-conductive winding. The process may further include processing the ultra-conductive winding using one or more rollers and a vacuum chamber.

### BRIEF DESCRIPTION OF THE DRAWINGS

The drawings described herein are for illustrative purposes only of selected configurations and are not intended to limit the scope of the present disclosure.

FIG. 1A is a front perspective view of a vehicle according to principles of the present disclosure;

FIG. 1B is an end view of an electric motor arranged in the vehicle of FIG. 1A;

FIG. 2 is a front perspective view of a system according to the principles of the present disclosure;

FIG. 3A is a front view of a system in a first position according to the principles of the present disclosure that includes a support in a first position;

FIG. 3B is a front view of the system of FIG. 3A in a second position according to the principles of the present disclosure;

FIG. 4A is sectional view of the system of FIG. 3A;

FIG. 4B is sectional view of the system of FIG. 3A;

FIG. 4C is sectional view of the system of FIG. 3A;

FIG. 4D is sectional view of the system of FIG. 3A;

FIG. 4E is sectional view of the system of FIG. 3A;

FIG. 4F is sectional view of the system of FIG. 3A;

FIG. 4G is sectional view of the system of FIG. 3A;

FIG. 4H is sectional view of the system of FIG. 3A;

FIG. 5A is an end view of a first configuration of an ultra-conductive winding according to the principles of the present disclosure;

FIG. 5B is an end view of a second configuration of an ultra-conductive winding according to the principles of the present disclosure;

FIG. 6A is side view of a comforting system according to the principles of the present disclosure;

FIG. 6B is side view of another comforting system according to the principles of the present disclosure; and

FIG. 7 is a side view of a vacuum chamber according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

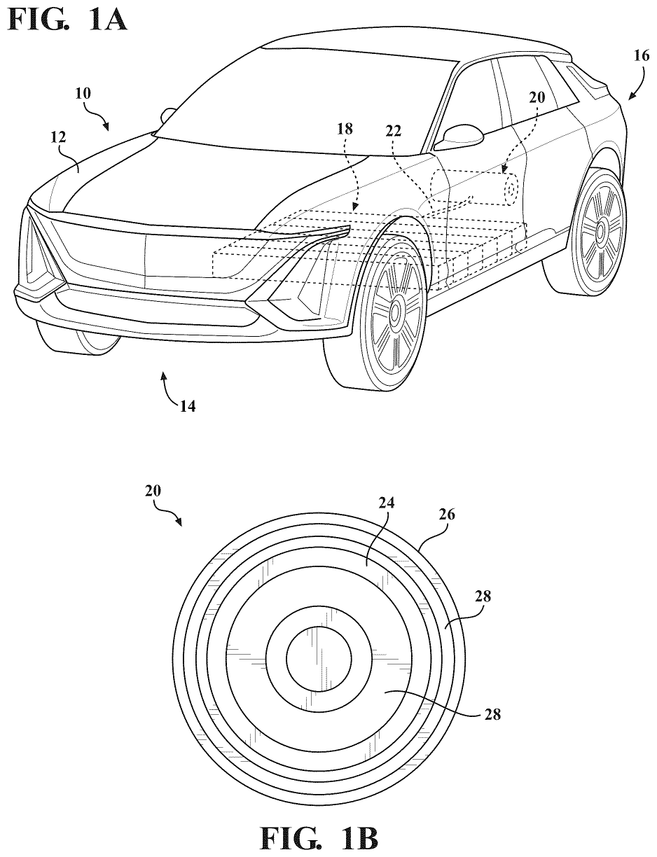

With reference to FIG. 1, an illustrative example of a vehicle 10 is provided. The vehicle 10 has a vehicle body 12 extending between a first end 14 and a second end 16. The vehicle 10 includes a power reservoir (e.g., battery pack) 18 and an electric motor 20 communicatively coupled to the power reservoir via a cable 22. With reference to FIG. 1B, the electric motor 20 includes a rotor 24 and a stator 26. The rotor 24 and the stator 26 each include one or more windings 28 that define electrical paths for current flow. In some configurations, the windings 28 can also be referred to as hairpin windings or ultra conductive windings (discussed in more detail below). Efficiency, thermal management, and/or power density of the windings 28 can be improved by treating, coating, and/or wrapping the windings 28 with another material before being arranged with respect to the rotor 24 and the stator 26.

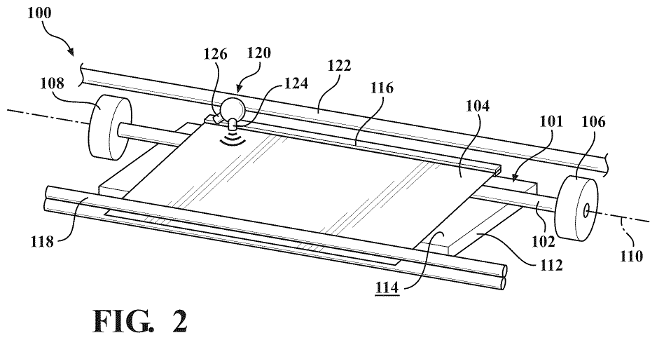

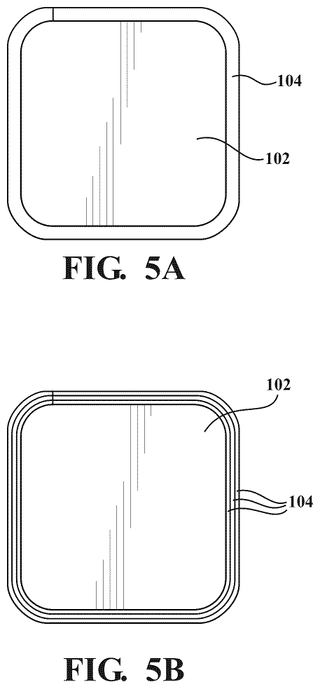

With reference to FIG. 2, an illustrative example of a system 100 is provided for manufacturing ultra-conductive windings 101. In other words, the system 100 can be configured for treating, coating, and/or wrapping a substrate 102 with an ultra-conductive composite (UCC) material 104. The substrate 102 can be made of copper or another conductive material that can be formed into a wire or bar, for example. According to one aspect, the substrate 102 can have a rectangular cross section, as shown in FIGS. 5A and 5B. The principles of the present disclosure equally apply to substrates with other cross sections, such as round, triangular, or other shapes. The substrate 102 can have rounded or smooth edges and corners to prevent and/or minimize tearing (i.e., ripping) of the UCC material 104 when the UCC material 104 is being applied to the substrate 102.

The UCC material 104 exhibits an electrical conductivity that surpasses other conductive materials such as copper or aluminum. The UCC material 104 can include a matrix of conductive polymers, metals, or carbon-based materials such as graphene or carbon nanotubes. One or more of these components can be arranged in a thin film or foil (FIG. 2) that conducts electricity with minimal resistance while maintaining structural integrity, flexibility, and durability. According to at least one aspect, the UCC material 104 can have a thickness from 5 to 30 micrometers (um) including all end points.

With reference to FIG. 2, the substrate 102 extends between a first articulation device 106 and a second articulation device 108. The first and second articulation devices 106, 108 can be wheels or stepper motors, for example. The articulation devices 106, 108 can be configured to rotate the substrate 102 about a longitudinal axis 110 so that a perimeter of the substrate 102 can be exposed to the UCC material 104. The articulation devices 106, 108 can be configured to rotate the substrate 102 simultaneously and in increments of 45, 90, or 180 degrees about the longitudinal axis 110, for example.

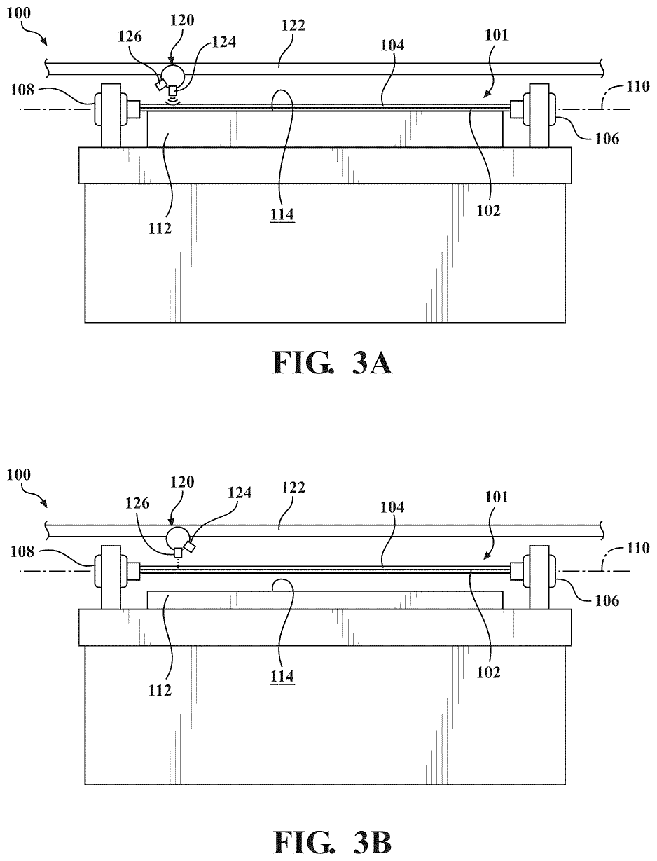

With reference to FIGS. 3A and 3B, a substrate support 112 can be arranged with respect to the substrate 102 and can be configured to engage the substrate 102 in a first position (FIG. 3A). More particularly, the substrate support 112 includes an upper surface 114 that contacts a portion of the substrate 102 and/or the UCC material 104 between the articulation devices 106, 108. The substrate support 112 can help prevent the substrate 102 and/or the UCC material 104 from bending or flexing away from the longitudinal axis 110 or away from each other during a joining process (discussed in more detail below). The substrate support 112 can also oppose a force applied by a joining device during the joining process introduced in more detail below. In a second position (FIG. 3B), the substrate support 112 is spaced from the substrate 102 and the UCC material 104 so that the articulation devices 106, 108 can rotate the substrate 102 about the longitudinal axis 110.

With reference again to FIG. 2, the system 100 can include a holder 116 and a tensioner 118 for positioning the UCC material 104 with respect to the substrate 102. The holder 116 can include a clamp or another gripping device that is configured to handle the UCC material 104 or another conductive material. The holder 116 and the tensioner 118 can work in tandem to position the UCC material 104 on or adjacent to a portion of the substrate 102. As will be discussed below, the tensioner 118 can be configured to continuously hold and/or feed the UCC material 104 until the UCC material 104 is coupled to or otherwise attached to the substrate 102.

A finishing mechanism 120 can be positioned with respect to the substrate 102 and the UCC material 104. For instance, a rail 122 can be arranged parallel to the longitudinal axis 110 and the finishing mechanism 120 can be positioned on and move along the rail 122 between the first and second articulation devices 106, 108. The finishing mechanism 120 can include a joining or coupling mechanism 124 and a cutting or separation mechanism 126. The joining mechanism 124 can include an ultrasonic horn that is configured to couple or otherwise attach the UCC material 104 with the substrate 102. According to one aspect, welding parameters of the ultrasonic horn can include an amplitude between 30-40 micrometers (um), a pressure of 70-120 Newtons (N), a hold time 0.15-0.3 seconds(s), and a frequency of about 20 kilohertz (KHz). The cutting mechanism 126 can include a laser or rotary knife that is configured to cut the UCC material 104. Note, in another configuration, the finishing mechanism 120 can be positioned on and controlled by a multi-axis robot that is configured to move throughout the operating environment and engage with the substrate 102 and/or the UCC material 104.

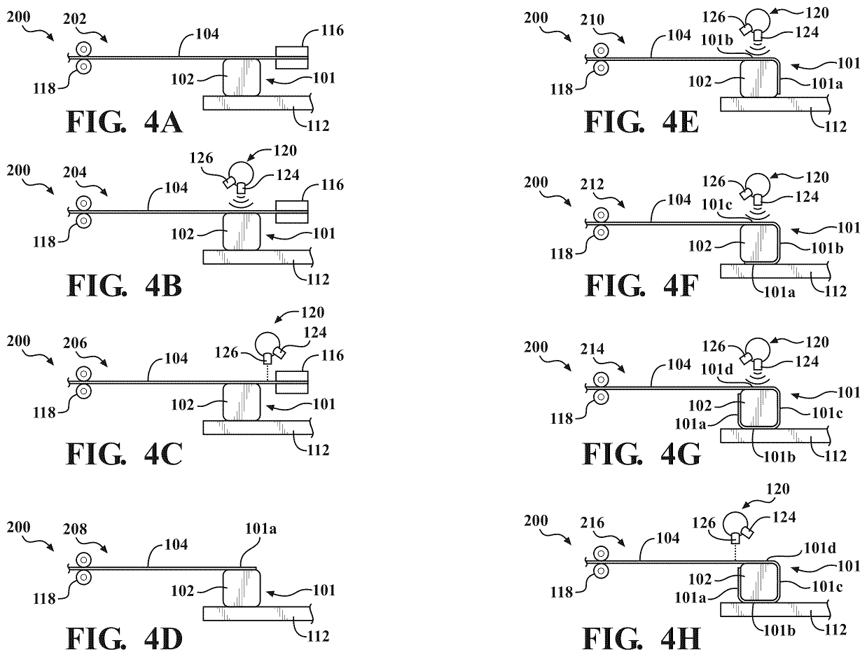

With reference to FIGS. 4A-4H, an illustrative example of a method 200 of assembling the UCC material 104 on the substrate 102 is provided. Note, while not readily shown in the figures, the substrate 102 is held by the articulation devices 106, 108 in the same or similar manner to that shown in the illustrative example of FIGS. 3A and 3B.

With reference to FIG. 4A, at 202, the UCC material 104 is held between the tensioner 118 and holder 116 so that the UCC material 104 contacts, overlaps, or is arranged adjacent to at least a portion of the substrate 102. In the present example, the UCC material 104 contacts a portion of at least one side of the substrate 102.

With reference to FIG. 4B, at 204, the finishing mechanism 120 can be positioned with respect to where the UCC material 104 contacts the substrate 102. More particularly, the joining mechanism (e.g., the ultrasonic horn) 124 can be arranged adjacent or overtop of where the UCC material 104 overlaps the substrate 102. The joining mechanism 124 is configured to travel along the rail 122 (FIGS. 3A and 3B) while coupling or otherwise attaching the UCC material 104 to the substrate 102 to form a first side 101a of the ultra-conductive winding 101.

With reference to FIG. 4C, at 206, the finishing mechanism 120 can be positioned with respect to a region between the first side 101a of the ultra-conductive winding 101 and the holder 116. More particularly, the cutting mechanism (e.g., laser or rotary knife) 126 can be arranged adjacent or overtop of the UCC material 104 and between the ultra-conductive winding 101 and the holder 116. The cutting mechanism 126 is configured to travel along the rail 122 (FIGS. 3A and 3B) while cutting through the UCC material 104 and separating the ultra-conductive winding 101 from the holder 116.

With reference to FIG. 4D, at 208, a portion of the ultra-conductive winding 101 is supported by the substrate support 112. While not shown in FIG. 4D, the substrate support 112 can move to the second position (FIG. 3B) where the upper surface 114 is spaced from the substrate 102 and the first and second articulation devices 106, 108 (FIG. 3B) can then rotate the substrate 102 about the longitudinal axis 110. In the present illustrative example, the substrate 102 can be rotated in increments of 90 degrees and, in doing so, another portion of the UCC material 104 overlaps another side of the substrate 102.

With reference to FIG. 4E, at 210, the finishing mechanism 120 can be positioned with respect to where the UCC material 104 contacts the substrate 102. More particularly, the joining mechanism (e.g., the ultrasonic horn) 124 can be arranged adjacent or overtop of where the UCC material 104 overlaps the substrate 102. The joining mechanism 124 is configured to travel along the rail 122 (FIGS. 3A and 3B) while coupling or otherwise attaching the UCC material 104 to the substrate 102 to form a second side 101b of the ultra-conductive winding 101.

With reference to FIG. 4F, at 212, the substrate 102 can be rotated again so that another portion of the UCC material 104 overlaps another portion of the substrate 102. The finishing mechanism 120 can be positioned with respect to where the UCC material 104 contacts the substrate 102. More particularly, the joining mechanism (e.g., the ultrasonic horn) 124 can be arranged adjacent or overtop of where the UCC material 104 overlaps the substrate 102. The joining mechanism 124 is configured to travel along the rail 122 (FIGS. 3A and 3B) while coupling or otherwise attaching the UCC material 104 to the substrate 102 to form a third side 101c of the ultra-conductive winding 101.

With reference to FIG. 4G, at 214, the substrate 102 can be rotated again so that another portion of the UCC material 104 overlaps another portion of the substrate 102. The finishing mechanism 120 can be positioned with respect to where the UCC material 104 contacts the substrate 102. More particularly, the joining mechanism (e.g., the ultrasonic horn) 124 can be arranged adjacent or overtop of where the UCC material 104 overlaps the substrate 102. The joining mechanism 124 is configured to travel along the rail 122 (FIGS. 3A and 3B) while coupling or otherwise attaching the UCC material 104 to the substrate 102 to form a fourth side 101d of the ultra-conductive winding 101.

With reference to FIG. 4H, at 216, the finishing mechanism 120 can be positioned with respect to a region between the ultra-conductive winding 101 and the tensioner 118. More particularly, the cutting mechanism (e.g., laser or rotary knife) 126 can be arranged adjacent or overtop of the UCC material 104 and between the ultra-conductive winding 101 and the tensioner 118. The cutting mechanism 126 is configured to travel along the rail 122 (FIGS. 3A and 3B) while cutting through the UCC material 104 and separating the ultra-conductive winding 101 from the tensioner 118. With reference to FIG. 5A, a single layer of UCC material 104 is wrapped and/or applied to the perimeter of the substrate 102.

Alternatively, rather than cutting the UCC material at 216, the substrate 102 can be rotated again so that the UCC material 104 overlaps the first side 101a of the ultra-conductive winding 101. The joining mechanism 124 can couple the UCC material 104 to the first side 101a of the ultra-conductive winding 101. This can be repeated so that several layers of the UCC material 104 are formed about the perimeter of the substrate 102, as shown in FIG. 5B.

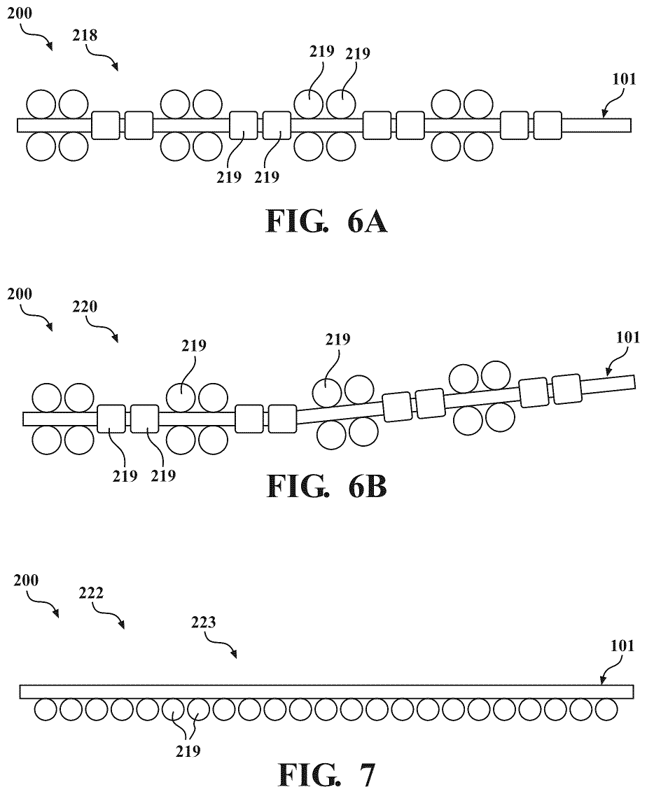

With reference to FIGS. 6A and 6B, the method 200 can optionally include a comforting process that further seats or positions the UCC material 104 with respect to the substrate 102. According to one aspect, the comforting process can include manipulating, conforming, shaping, and/or other metal forming processes that may be desirable for further positioning the UCC material 104 with respect to the substrate 102.

With reference to FIG. 6A, at 218, one or more roller wheels 219 contact the ultra-conductive winding 101 and further establish the connection between the UCC material 104 and the substrate 102.

With reference to FIG. 6B, at 220, the one or more roller wheels 219 are positioned to contact and deform (i.e., bend) the ultra-conductive winding 101. This can be desirable to further establish the connection between the UCC material 104 and the substrate 102.

With reference to FIG. 7, the ultra-conductive winding 101 can be placed in a vacuum chamber 223 so that the UCC material 104 can be metallurgically bonded to the substrate 102 and further enhance the connection between the UCC material 104 and the substrate 102. According to one aspect, the metallurgical bonding may be carried out at a temperature between 500 and 800 degrees Celsius (° C.). According to another aspect, the ultra-conductive winding 101 may be treated in the vacuum chamber 223 from 10 minutes to five hours including all end points.

Finally, while not readily shown in the figures, the ultra-conductive winding 101 can be insulated and/or coated with a polymer. For instance, various types of enamel, such as polyurethane (PU), polyester (PEI), polyetheretherketone (PEEK), polyamide-imide (PAI), polyimide (PI), polyvinyl formal (PVF), or epoxide can be applied (e.g., sprayed, etc.) to the ultra-conductive winding 101.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for manufacturing an ultra-conductive winding for an electric motor of a vehicle, the system comprising:
a substrate extending along a longitudinal axis;
an ultra-conductive composite (UCC) foil material having a thickness of 5-30 micrometers and overlapping a portion of the substrate;
a substrate support selectively engageable with a portion of the substrate or the UCC material; and
a finishing mechanism including a joining mechanism and a cutting mechanism, the finishing mechanism being configured to move along or parallel to the longitudinal axis.

2. The system of claim 1, further including a first articulation device and a second articulation device spaced from the first articulation device.

3. The system of claim 2, wherein the first articulation device and the second articulation device are stepper motors configured to rotate the substrate with respect to the longitudinal axis.

4. The system of claim 2, wherein the substrate extends between the first articulation device and the second articulation device and between a tensioner and a holder.

5. The system of claim 1, wherein the substrate is made of copper and includes a rectangular cross section.

6. The system of claim 1, wherein the substrate can be made of copper and can include a round cross section.

7. The system of claim 1, wherein the finishing mechanism is positioned on a rail that is arranged parallel to the longitudinal axis.

8. The system of claim 7, wherein the finishing mechanism is movable along the rail between a first articulation device and a second articulation device.

9. The system of claim 1, wherein the joining mechanism is an ultrasonic horn.

10. The system of claim 1, wherein the cutting mechanism is a laser.

11. A system for manufacturing an ultra-conductive winding for an electric motor, the system comprising:
a first articulation device and a second articulation device spaced from the first articulation device;
a substrate extending along a longitudinal axis and held by the first articulation device and the second articulation device;
an ultra-conductive composite (UCC) material held by a tensioner and selectively by a holder, the UCC material overlapping a portion of the substrate;
a substrate support selectively engageable with a portion of the substrate or the UCC material; and
a finishing mechanism including a joining mechanism and a cutting mechanism that are selectively movable with respect to where the UCC material overlaps the substrate, the finishing mechanism being configured to move between the first articulation device and the second articulation device.

12. The system of claim 11, wherein the first articulation device and the second articulation device are configured to rotate the substrate about the longitudinal axis.

13. The system of claim 11, wherein the joining mechanism is configured to couple the UCC material to a portion of a perimeter of the substrate.

14. The system of claim 13, wherein the joining mechanism is an ultrasonic horn.

15. The system of claim 11, wherein the cutting mechanism is a laser.

16. An ultra-conductive winding for an electric motor formed by a process comprising:
positioning an ultra-conductive composite (UCC) material with respect to a substrate;
coupling the UCC material to a first portion of the substrate with a joining mechanism to form a first side of the ultra-conductive winding;
cutting the UCC material with a cutting mechanism;
rotating the substrate about a longitudinal axis; and
coupling another portion of the UCC material to another portion of the substrate with the joining mechanism to form a second side of the ultra-conductive winding.

17. The ultra-conductive winding of claim 16, wherein the process further includes rotating the substrate about the longitudinal axis and coupling another portion of the UCC material to another portion of the substrate with the joining mechanism to form a second side of the ultra-conductive winding.

18. The ultra-conductive winding of claim 17, wherein the process further includes rotating the substrate about the longitudinal axis and coupling another portion of the UCC material to another portion of the substrate with the joining mechanism to form a third side of the ultra-conductive winding.

19. The ultra-conductive winding of claim 18, wherein the process further includes rotating the substrate about the longitudinal axis and coupling another portion of the UCC material to another portion of the substrate with the joining mechanism to form a fourth side of the ultra-conductive winding.

20. The ultra-conductive winding of claim 19, wherein the process further includes processing the ultra-conductive winding using one or more rollers and a vacuum chamber.
